(19) United States
(12) Patent Application Publication
(10) Pub. No.: US 2001/0051998 A1
(43) Pub. Date: Dec. 13, 2001

(54) Network interface having client-specific information and associated method

(76) Inventor: Hendrick P. Henderson, Denton, TX (US)

Correspondence Address: Brian W. Peterman, O'KEEFE, EGAN & PETERMAN, Building C, Suite 200, 1101 Capital of Texas Highway South, Austin, TX, 78746, US

(21) Appl. No.: 09/877,559

(22) Filed: Jun. 8, 2001

Related U.S. Application Data
(63) Continuation-in-part of application No. 09/591,134, filed on Jun. 9, 2000.

(51) Int. Cl. G06F 15/16

(52) U.S. Cl. 709/217; 709/203

(57) ABSTRACT

A network browser interface having client-specific information and associated method are disclosed that provide improved client-specific advertising and marketing to network users. The present invention takes advantage of program interfaces with client-specific or co-branded information to deliver, in part, substantially continuous client-specific advertising to users. The present invention also provides additional advantageous features for a network browser. The network may be the Internet, intranet networks, or other networks linking together multiple users.

### RELATED APPLICATIONS

This application is a continuation-in-part application of the following co-pending application: Application USSN 09/591,134 entitled “NETWORK INTERFACE HAVING CLIENT-SPECIFIC INFORMATION AND ASSOCIATED METHOD,” which was filed on Jun. 9, 2000, and which is hereby incorporated by reference in its entirety.

### BACKGROUND OF THE INVENTION

1. Field of the Invention

The present invention relates generally to systems and methods for providing access to network information, and more particularly to network browsers for the Internet and intranet networks.

2. Description of Related Art

The Internet is a rapidly expanding computer network linking smaller networks and individual computers around the world. Entities which make use of the Internet range from individuals to large corporations, schools and governments. Internet hosts include computers and/or networks of computers linked to the Internet that allow access to databases and facilitate exchange of information between users of the Internet. Users may include, but are not limited to, Internet-connected work stations, notebook computers, home computers (PC's), bulletin board systems, personal digital assistants, hand-held computers, Internet appliances, host computers, cell phones, pagers, televisions and various other processing systems that are connected to receive or provide information through the Internet.

Internet hosts may employ computer servers to make available files, images, sounds, documents or other information to Internet users requesting such information. Such information may be stored, for example, on suitable storage media, including magnetic storage devices (such as tape drives or disks), optical storage devices (such as optical disks), or other storage devices. Private intranet networks also exist and may be used to link a number of users and hosts (e.g., employees of a corporation or institution) in a manner similar to the Internet. These intranet networks are typically closed to outside users. In addition, other networks, such wide area networks (WANs), local area networks (LANs), and wireless networks exist and may be used to link users within a business, home or other environment.

Communication between host Internet or web server computers and user computers may be accomplished using any desired networking protocol. For example, protocols may be used, such as the Internet protocol (“IP”), and a communication protocol known as hyper-text transfer protocol (“HTTP”). Information may be transferred from a host to a user in the form of documents, such as web pages, using a document protocol, such as hyper-text markup language (“HTML”), which may be interpreted by a network browser to create a web page display on a user computer system. Uniform resource locators (“URLs”) may be used to identify web pages located on web servers, and a user of a web browser may request a web page by entering a corresponding URL into the web browser.

Alternatively, a search engine may be employed to search for and list web pages corresponding to particular criteria, such as web page title or key words. A user may then select web pages from such a list. Pre-defined links may also be provided in a displayed web page that contain the URL or address of other web pages. These links may be selected by the user, for example using a mouse and pointer, to direct the web browser to request a particular web page. In any case, when a web browser requests a specific web page from a web server, the server receives the request and packages and transmits the web page to the web browser for display.

Exploitation of the information-sharing features offered by the Internet has become increasingly popular among corporations and other commercial entities. Such commercial uses include, but are not limited to, on-line sales and auctions, as well as marketing tools such as advertising banners or actual web page links that are displayed on particular web pages or web sites and that promote a variety of products or services from various vendors, who in return pay the sponsor of the web page or web site for this advertising. Such advertising is common, and may conflict with other information presented on a given web page or web site. For example, a web page displaying a banner advertising the product of one company may at the same time contain links to a competitor's web page. Furthermore, when a large number of advertising banners from different vendors are displayed sequentially and/or concurrently, users of web browsers may tend to ignore the commercial messages presented thereupon.

### SUMMARY OF THE INVENTION

The present invention provides a network browser interface having client-specific information and associated method. This interface and associated method achieves advertising, branding and marketing techniques that more effectively target and deliver advertisements to network users. The present invention takes advantage of program interfaces with client-specific or co-branded information to deliver, in part, substantially continuous client-specific advertising to users. The present invention also provides additional advantageous features for a network browser. The network may be the Internet, intranet networks, or other networks linking together multiple users.

In one embodiment, the present invention is a client-specific network browser interface including a user interface, a first area within the user interface that includes space in which network information is displayed, and a second area within the user interface that includes space in which client-specific information is displayed substantially continuously to a user, with the client-specific information being information dedicated to at least one vendor that is not a developer of the browser interface program and with at least a portion of the client-specific information being updated with content provided by a remote server during times when the network is being accessed. In more detailed respects, at least some of the content is provided in an HTML-based format, and the updated portion of the client-specific information includes at least two distinct spaces that display dynamically linked client-specific information.

In another embodiment, the present invention is a client-specific network browser interface including a user interface, a first area within the user interface that includes space in which network information is displayed, and a second area within the user interface that includes space in which client-specific information is displayed substantially continuously to a user, with the client-specific information being information dedicated to at least one vendor that is not a developer of the browser interface program. The user interface also includes program command and control information having a link to settings that allow access to network content to be controlled. In more detailed respects, the network includes the Internet, and the content access control settings include web site addresses that identify web sites that should not be accessed. Still further, the content access control settings can include words or phrases that identify web site content that should not be accessed, and the content access control settings can include data obtained from a database located on a remote server.

In yet another embodiment, the present invention is a client-specific network browser interface including a user interface, a first area within the user interface that includes space in which network information is displayed, and a second area within the user interface that includes space in which client-specific information is displayed substantially continuously to a user, with the client-specific information being information dedicated to at least one vendor that is not a developer of the browser interface. The user interface also includes program command and control information having a link to settings that allow network related activity to be observed and logged. In more detailed respects, the network can include the Internet, and logged data representative of network related activity is stored on a remote server. In addition, a portion of the logged data can be made accessible for review by an authorized person, and a portion of the logged data can be forwarded from the remote server to an authorized person for review. Still further, the network browser interface can be a graphical user interface or a text-based or character-based user interface.

In still another embodiment, the present invention is a processing system having a client-specific network browser interface including an internal processor, a display device coupled to the internal processor, an input device coupled to the internal processor, a communication device coupled to the internal processor and configured to allow the processing system to communicate to a network, and a browser interface configured to be displayed through the user display. The browser interface includes a first area that includes space in which network information is displayed, and a second area that includes space in which client-specific information is substantially continuously displayed to a user, with the client-specific information being information dedicated to at least one vendor that is not a developer of the browser interface program and with at least a portion of the client-specific information being updated with content provided by a remote server during times when the network is being accessed. In a further embodiment, the browser interface may also include program command and control information having a link to settings that allow access to network content to be controlled and having a link to settings that allow network related activity to be observed and logged.

In another embodiment, the present invention is a processing system having a network browser interface including an internal processor, a display device coupled to the internal processor, an input device coupled to the internal processor, a communication device coupled to the internal processor and configured to allow the processing system to communicate to a network, and a browser interface configured to be displayed through the user display. The browser interface includes a first area that includes space in which network information is displayed and is configured to provide multi-thread data transfers through the network. In more detailed respects, the browser interface can include a second area that includes space in which client-specific information is substantially continuously displayed to a user, with the client-specific information being information dedicated to at least one vendor that is not a developer of the browser interface program. Still further, the browser interface can include program command and control information having a link to settings that determine whether or not multi-thread transfers are utilized for data transfer through the network. Another link may also be provided to settings that determine the number of threads that will be utilized. In addition, the network can include the Internet, and the browser interface can be configured to download content associated with links on a web page once the web page is viewed instead of waiting for a new link to be selected by a user. Still further, a link can be provided to access time control settings that allow a user to select network information to download and to determine when and how often the selected network information is downloaded or updated from the network, with the selected network information being downloaded using multi-thread data transfers.

In a further embodiment, the present invention is a method for providing network information through a client-specific network interface including displaying network information within a first area within a user interface, further displaying client-specific information within a second area within the user interface where the client-specific information is information dedicated to at least one particular vendor that is not a developer of the network interface program, and updating at least a portion of the client-specific information with content provided by a remote server during times when the network is being accessed. In addition, the method may include allowing access to network content to be controlled through content access control settings, and setting data can obtained from a database located on a remote server. Still further, the network can be the Internet, and the method may further include storing logged data representative of network related activity on a remote server.

In yet another embodiment, the present invention is a method for enhancing data transfers for a network user interface including displaying network information within a first area within a user interface, and transferring data for the network user interface through the network utilizing multi-thread data transfers. The method may further include displaying a second area that includes space in which client-specific information is substantially continuously displayed to a user, with the client-specific information being information dedicated to at least one vendor that is not a developer of the browser interface program. In addition, the method may include providing program command and control information including a link to settings that determine whether or not multi-thread transfers are utilized for data transfer through the network. In addition, the network can be the Internet, and the method may include downloading content associated with links on a web page once the web page is viewed instead of waiting for a new link to be selected by a user. Still further, the data transfer can include video files.

### BRIEF DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1 is a simplified block diagram for network system according to the present invention.

FIG. 2A is a functional block diagram for a client-specific network interface according to the present invention.

FIG. 2B is a block diagram for a user processing system with a client-specific network interface according to the present invention.

FIG. 3A is a block diagram for an operating system interface on a computer screen according to the present invention.

FIG. 3B is a block diagram of a client-specific pop-up page for a client-specific network interface according to the present invention.

FIG. 3C is a more detailed diagram for a client-specific pop-up page for a client-specific network interface according to the present invention.

FIG. 4A is a block diagram for a client-specific browser interface for a client-specific network interface according to the present invention.

FIG. 4B is a more detailed diagram for a client-specific browser interface for a client-specific network interface according to the present invention.

FIG. 5 is another more detailed diagram for a client-specific browser interface for a network interface according to the present invention.

FIG. 6 is a detailed diagram for an example interface for a web page download scheduler feature according to the present invention.

FIG. 7. is a detailed diagram for an example interface for a device activity observation feature according to the present invention.

FIG. 8 is a detailed diagram for an example interface for an access control feature according to the present invention.

### DESCRIPTION OF ILLUSTRATIVE EMBODIMENTS

Although specific embodiments are described herein in relation to Internet network applications, it will be understood with benefit of this disclosure by those of skill in the art that the disclosed systems and methods may also be utilized with private intranet systems as well as any other computer network systems in which host and user computers, or other arrangements of multiple computers, interface and exchange information.

The present invention provides a network browser interface having client-specific information and associated method. This interface and associated method achieves marketing and advertising techniques that more effectively target and deliver advertisements to network users. The present invention takes advantage of program interfaces with client-specific or co-branded information to deliver, in part, substantially continuous client-specific advertising to users. The present invention also provides additional advantageous features for a network browser.

As used herein, “co-branded” network interface refers to a network interface, such as a browser program interface, pop-up page, or menu, that includes advertising or brand information directed to particular third party vendor or entity (referred to herein as a “client”), such as an advertising banner, advertising window, link to the client's web page or other information. Thus, although the browser software program may be developed by one company, such as eCLIK Corporation in the examples below, the browser interface displays client-specific information about the third-party vendor, such as Blue.Sky Airlines in the examples below. In other words, there may be two brands associated with the browser.

As used here, “client-specific” refers to advertising on a network display that is limited to a specific client or group of clients, such as related or affiliated companies, rather than distributed among many different advertisers, for example those who pay for banner adds on existing web pages. As discussed in more detail below with respect to the embodiments shown in the drawings, the client-specific information may be a wide variety of information and brands associated with a particular client or groups of clients. However, since this client-specific information takes up dedicated space on the browser interface, the user is viewing the advertising and marketing message substantially continuously. This client-specific interface, therefore, is in stark contrast to prior advertising, such as those that employ transient and often conflicting banner advertising on Internet web pages.

The client-specific network interface of the present invention, therefore, advantageously provides a technique for targeting network users with advertising from a single co-branded client or group of clients, thus providing a more consistent and coherent message to the consumer. Where more than one co-branded web display is linked, such as when a co-branded menu contains links to co-branded web pages containing advertising or services or products from the same client, network users are more likely to purchase services or products from the co-branded client. Furthermore, with the Internet, the shopping experience may be enhanced for the consumer by providing the Internet user with links to services, products, promotions, etc. offered by the client or a separate vendor that the consumer trusts. Thus, exchange of commercial information and transaction costs may be reduced for the consumer, while at the same time generating greater return on advertising for the client.

In addition, the network interface of the present invention may provide client-specific advertising and/or client-specific links that may be displayed with user specific software utilities having unique or favorable operating characteristics to enhance consumer desire for the software utilities. User specific software utilities may be provided at free or minimal charge to affiliates or customers of existing corporate entities, for example, to members of an airline frequent flier program. In such cases, client-specific links to the airline frequent flier program, as well as to other products and services offered under the airline's corporate umbrella, may be included. Client-specific software utilities may also be provided to schools and educational facilities or to employees of corporate or government entities that wish to promote access and use of client-specific links and/or messages, such as client-specific advertising. In this regard, several major corporations have announced programs for supplying their employees with computer equipment and software, which may easily include one or more user specific utility components of the present invention. User specific utilities may be any software or software code package that may be used to display client-specific advertising in a network interface, such as a browser, pop-up page, menu or to other display or communication of client-specific advertising information in a network interface to a user.

As further discussed below, client-specific web pages may be linked via a co-branded page or menu, such as a pop-up page or menu. Content of web pages may be advantageously stored, downloaded and/or updated onto the user's local computer system automatically when the user's system is accessing the network, so as to minimize necessity of a network connection and/or download waiting time each time the user desires to view the web page. Such “off-line” web pages may be updated at regular intervals, or at other times upon a request from a user computer and/or by transmittal from a host computer. In this way, offline web page content may be kept up to date and ready for substantially instant access by the user, or printing out by a user computer.

In this context, “off-line” is used to refer to times in which the user is viewing selected web pages for which content information has previously been downloaded, so that the user is not actively accessing and downloading the particular selected web pages and/or actively accessing other network web pages. Similarly, in this context, “on-line” is used to refer to times in which the user is connected to the network and actively accessing and downloading the selected web pages and/or actively accessing other network web pages. For example, in an Internet modem dial-up environment, this operation may function so that selected web pages are downloaded or updated each time the system dials in and accesses the Internet. Thus, when a user wants to view this previously downloaded or updated web page content, the user may do so off-line without having to wait for the content to be downloaded. In addition, the user may set-up the user's system to automatically dial-in periodically to download and update these selected web pages. In a digital subscriber line (DSL) or cable modem Internet environment where the user's computer may always be connected to the network, the user's computer system may simply be set-up to periodically download or update the selected web pages. Thus, off-line viewing in this environment would refer the viewing of previously downloaded or updated web page content, whereas on-line viewing would refer to actively accessing and downloading the web page information when viewing is desired. It is noted that downloading and thereafter only updating portions of web pages that have changed since the last download are operations that would be known to one of skill in the art.

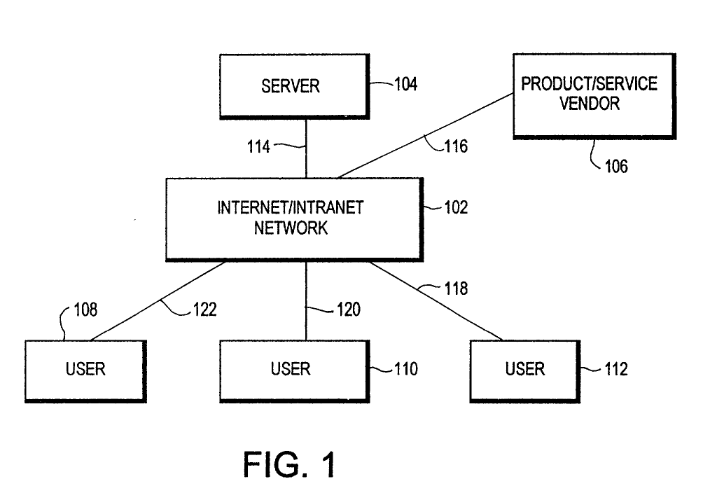

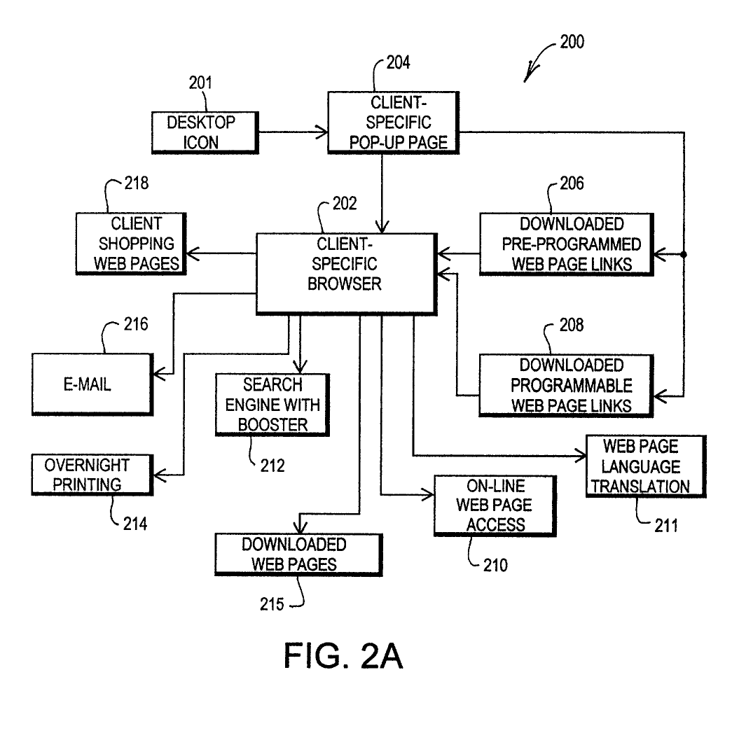

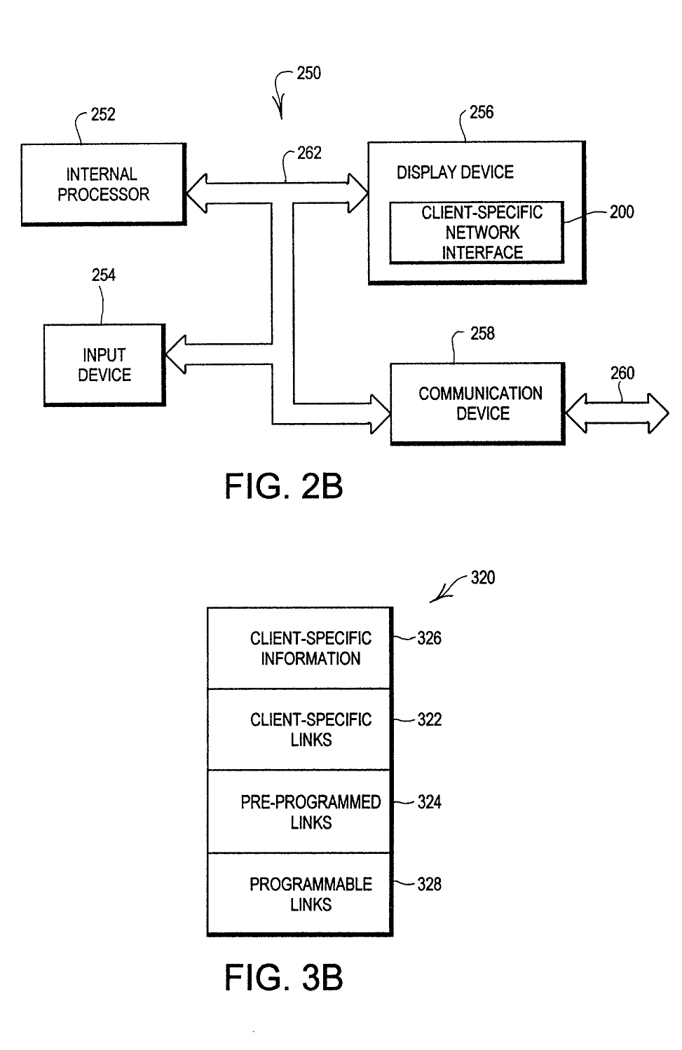

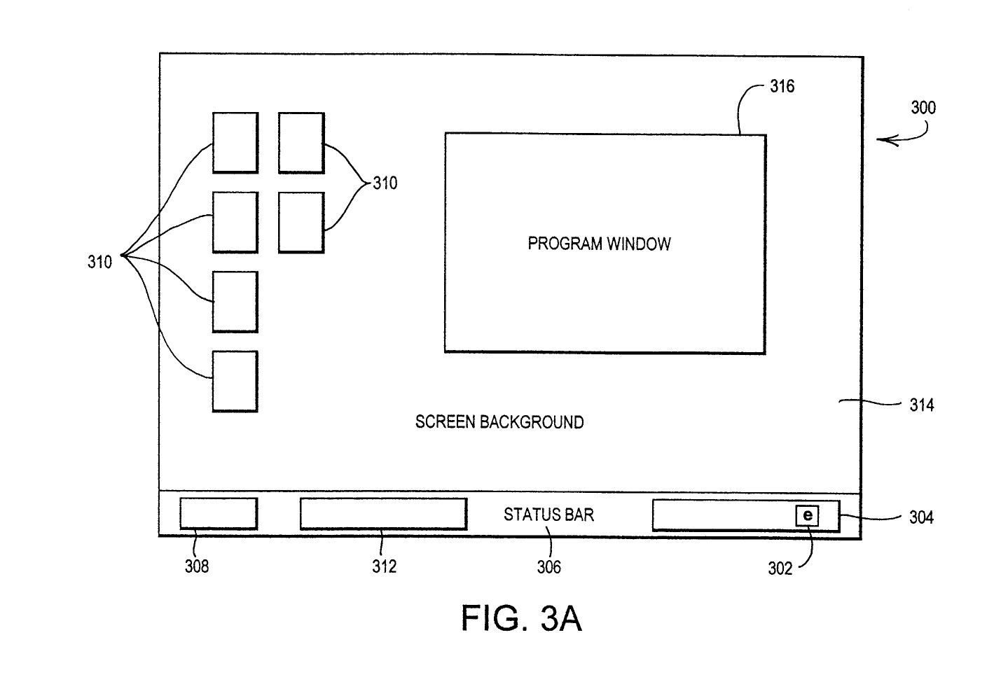

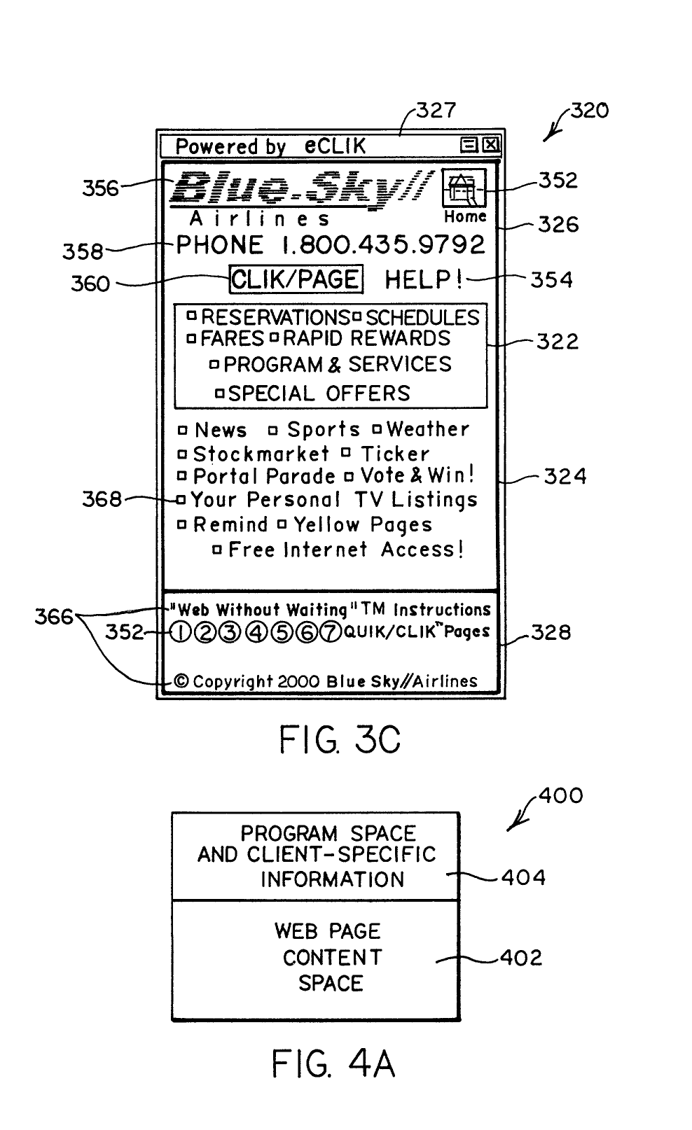

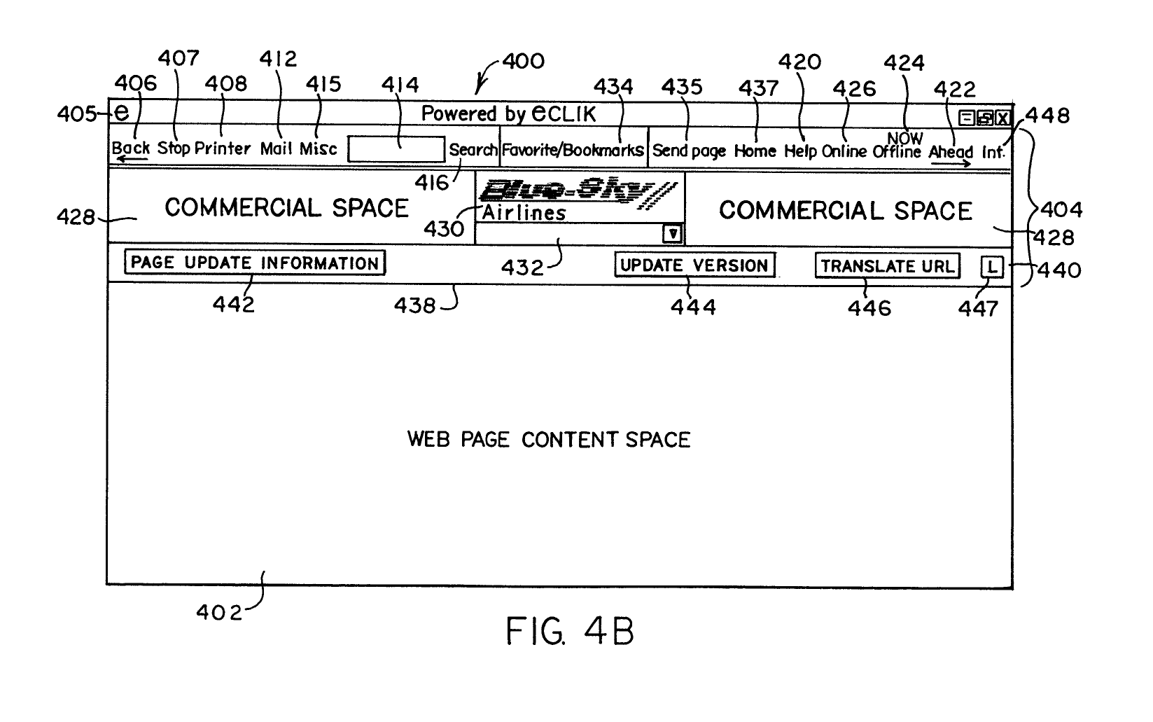

The present invention will now be described further with respect to the embodiments described in FIGS. 1, 2A-B, 3A-C and 4A-B. In particular, FIG. 1 provides a simplified block diagram of a network environment. FIG. 2A provides a functional block diagram of a network interface and additional operational features, according to the present invention. FIG. 2B provides a block diagram of a user processing system having a client-specific network interface. FIGS. 3A-C provide block diagrams and an example for a client-specific pop-up page, according to the present invention. And FIGS. 4A-B provide block diagrams and an example for a client-specific browser interface, according to the present invention. In the example embodiment depicted, eCLIK is used as the developer of the network interface browser software and as a service provider for other network services, such as electronic mail accounts and web page hosting. In the example embodiment depicted, Blue.Sky Airlines is used as the client product and/or service vendor whose client-specific and co-branded information is displayed through the network interface.

Although FIGS. 3A-C and FIGS. 4A-B show an embodiment providing a graphical user interface, it is noted that other user interfaces may also be utilized, as desired. For example, a text-based or a character-based interface could be utilized depending upon the user processing system with which the interface is used. Thus, the graphical user interface examples that are depicted in the drawings should be viewed as an embodiment of the invention and not as limiting the invention to a graphical user interface. The client-specific browser interface of the current invention would be equally advantageous for other interface formats.

Looking now to FIG. 1, a simplified block diagram is depicted for network system 100, according to the present invention. A server 104 and product and/or service vendor 106 may be connected to each other and to a plurality of users 108, 110 and 112 through a communication channels 114, 116, 118, 120 and 122 via a network 102. Network 102 may be, for example, the Internet, a private intranet network, a wide area network (WAN), a local area network (LAN), or any other type of computer network suitable for linking multiple computing systems. Communication channels 114, 116, 118, 120 and 122 to the network 102 may also include intervening connectivity systems such as modems and routers, as well as intervening computer systems, such as intranet portal computer systems and Internet service provider (ISP) computer systems. Communication channels 114, 116, 118, 120 and 122 may also be any connection, as desired, and may be, for example, wireless or direct wire connections. Thus, as would be understood by one of skill in the art, the user computer systems 108, 110 and 112 may be connected to the network 102 and ultimately to other computer systems on the network 102, such as server 104 and vendor 106, in any number of a variety ways as would be known in the art. It is also noted that although only server 104, vendor 106, and users 108, 110 and 112 are shown connected to each other through the network 102, any number of computer systems with any number of different configurations and functionality may be connected to the network 102, as is well understood by those of skill in the art.

To communicate, server 104 and users 108, 110 and 112 may use a two-way communication protocol, such as the HTTP Internet communication protocol, or any other suitable network protocol. Server 104 and users 108, 110 and 112 each may be, for example, computer systems having a memory storage device, processor and display. Examples of such equipment include, but are not limited to, a personal computer, computer work station, server systems, and other computer systems, available from a variety of computer and computer equipment suppliers.

The server 104, as well as other server computer systems connected to network 102, may provide a variety of functions and services for users 108, 110 and 112 connected to the network 102. For example, server 104 may provide standard Internet service provider (ISP) services, such as Internet e-mail accounts, domain name hosting, web page hosting, content control and Internet access. The server 104 may also provide portal and home page services for users 108, 110 and 112, including functionality such as search capabilities. Server 104 may also provide additional functions as would be understood by one of skill in the art.

The vendor 106 identifies a separate computer system connected to the network 102 of an third-party entity that desires to provide information, products, and/or services to users 108, 110 and 112. If a user 108 accesses the vendor 106 through the network 102, the vendor 106 would provide information, for example in the form of Internet web pages, to the user 108. These web pages may be interactive and allow the user 108 to purchase products or order services from the vendor 106. These web pages may be written, for example, in HTML format, and may be packaged and transmitted to user 108 through network 102 via communication paths 116 and 122. Vendor 106 may initiate packaging and transmittal of web pages to the user 108, and/or a vendor 106 may package and transmit web pages in response to a request from user 108 submitted via network 102.

FIG. 2A is a functional block diagram for an embodiment of a client-specific network interface 200 according to the present invention. In contrast with prior network interfaces and browsers that primarily enable the viewing of remote pages of information that include advertising from third party vendors of goods and services, the present invention contemplates a network interface that itself provides advertising and brand information that is dedicated to a particular vendor or group of vendors. Thus, when the user operates the network interface of the present invention, the client-specific information for this vendor or group of vendors is displayed to the user. Along with this client-specific network interface, the present invention contemplates providing substantially immediate access to a set of remote pages by downloading and updating these remote pages during times when the user is connected to the network. These downloaded pages, therefore, allow for off-line access of updated web page information, as mentioned above. The network interface of the present invention also contemplates numerous other features, for example, those additional features shown with respect to the embodiment in FIG. 2A.

Looking to the embodiment in FIG. 2A, a desktop icon 201 provides a link, when selected, to a pop-up page 204. According to the present invention, the pop-up page 204 includes information specific to a particular service or product vendor, as described in more detail with respect to FIGS. 3A-C. The client-specific pop-up page 204 will in turn provide links to a browser 202, which will also include information specific to a particular service or product vendor. The client-specific pop-up page 204 will also provide links to downloaded pre-programmed web page links 206 and to downloaded programmable web page links 208, which are described in more detail with respect to FIGS. 3A-C. Once selected, these downloaded web pages may be viewed through the client-specific browser 202.

The client-specific browser 202 includes links to various features that may be included within the browser programming. It is noted that these features may be included and implemented as desired. For example, the browser 202 may include links to client-specific web pages 218 (such as shopping pages), to an e-mail client application 216, to an overnight printing utility 214, to a search engine 212, web page translation 211, previously downloaded web pages 215, and on-line web page access 210. The client-specific browser 202 is described in more detail with respect to FIGS. 4A-B.

Referring now to FIG. 2B, a block diagram is depicted for an example user processing system 250 for the user systems 108, 110 and 112 depicted in FIG. 1. The user processing system may be personal computers, notebook computers, web enabled personal digital assistants, Internet appliances, palm-sized computers, cell phones, pagers, web enabled televisions, or any other processing system that is connectable to the network 102. In the embodiment shown, the user processing system 250 includes an internal processor 252, a display device 256, a communication device 258, an input device 254, and a communication bus 262 that couples them together. The client-specific network browser interface 200, according to the present invention, may be displayed to the user through the display device 256. The input device 254 allows for data, commands or other inputs to be received by the system 250 and processed by the internal processor 252.

The communication device 258 provides connectivity to an external network through channel 260. As indicated above, the communication device 258 and the channel 260 may be any of a variety of connection techniques. For example, the communication device 258 may be, for example, a telephone dial-up modem, a cable modem, an digital subscriber line (DSL), a cable modem, a wireless connection, or any other communication device. The communication device 258 may be, for example, an infrared radio frequency (RF) transceiver, or other wireless device that transmits and receives information to and from another device that provides further connectivity functions so that the processing system 258 may communicate with the network 102. The channel 260 may be a wide variety of wire or wireless connections depending upon the communication technique desired. Thus, any of a wide variety of communication techniques and protocols may be utilized to allow the processing system 250, having a client-specific network interface according the present invention, to send and receive information to and from the network 102.

FIG. 3A is a block diagram for an operating system interface 300 on a computer screen according to the present invention. The operating system interface 300 may be for example a graphical computer interface, such as those provided by operating systems available from Microsoft. A person typically interacts with such a graphical interface using a pointing device such as a mouse, touch-pad or track ball. In the embodiment shown in FIG. 3A, the interface 300 includes a status bar 306 and a screen background 314. Icons 310, which link to programs or files, may be positioned graphically on top of the background 314. An active program window 316 may also be located graphically on top of the background 314. As would be understood by one of skill in the art, the arrangement and functionality of this graphical interface 300 may be selected and designed as desired.

The status bar 306 may include a program and control buttons, such as button 308, that will provide a selection menu when activated. The status bar 306 may also include an indication of open programs, such as indication 312, for which the screen size has been reduced or minimized. In addition, the status bar may have a system task section 304 which includes icons representing programs or applications that are currently being run by the system. For example, for the Microsoft WINDOWS operating systems, this task section 304 is termed the “system tray” and includes icons such as a sound icon, anti-virus software icon and a printer icon, if background printing is occurring. According to the present invention, this task section 304 may also include a graphical link 302, such as an icon, linked to a pop-up page or menu, as described below.

It is noted that although the graphical link 302 is shown in FIG. 3A as being an icon in the task section 304, it may be any link designed and located so that it is accessible to the user on the graphical interface 300. For example, it could be a graphical icon link that sits on top of the background 314. If desired, this graphical link may be programmed such that it is always displayed to the user regardless of what the user is doing with respect to the graphical interface 300. Still further, this graphical link may have user selectable features in how it is displayed to the user. For example, the user could select where the graphical link would appear, could move it around the graphical interface 300, could determine whether it is always displayed to the user, and/or choose other selectable features. It is further noted that any arrangement of text or images may be used for the graphical link as would be understood by one of skill in the art.

FIG. 3B is a block diagram of an embodiment for a client-specific pop-up page 320 for a client-specific network interface according to the present invention. In the embodiment shown, the client-specific pop-up page 320 includes a plurality of different areas 322, 324, 326 and 328, in which different types of information may be displayed. For example, area 326 may include client-specific information. The area 322 may include client-specific links that, when selected, take a user to a web page for the product or service vendor. The area 324 may include other links that, when selected, take a user to various web pages. These client-specific links in area 322 and other links in area 324 may be pre-programmed for the client-specific pop-up page 320. The area 328, in contrast, may include user links that are programmed by the user to provide a link to any web page that the user selects. It is noted that these areas in the embodiment of FIG. 3B are for example purposes and other arrangements for a client-specific pop-page or menu 320 would be equally advantageous, according to the present invention.

FIG. 3C is a more detailed diagram of an embodiment for a client-specific pop-up page 320 for a client-specific network interface according to the present invention. As with FIG. 3B, area 326 includes client-specific information, area 322 includes client-specific links, area 324 includes other links, and area 328 includes user programmed links. The program header line 327 includes controls for a graphical interface windowing environment and the phrase “Powered by eCLIK,” which may represent the source of the software programming. It is noted that the particular configuration and links shown in FIG. 3C are intended as an example and should not be seen as limiting the invention.

More particularly in the example shown, the area 326 includes a mark or brand 356 represented by the brand “Blue.Sky Airlines,” a link 354 to a “Help” utility represented by the “HELP!” link, a message 358 represented by the phrase “Phone 1.800.435.9792,” message 360 represented by the text “CLIK/PAGE,” and a icon 352 that provides a link to the home page for the goods and service vendor “Blue.Sky Airlines.”

Looking more particularly to area 322, web page links are provided to particular product offerings of the vendor. For example, these may be for the “Blue.Sky Airlines” vendor: Reservations, Schedules, Fares, Rapid Rewards, Program & Services and Special Offers. In addition to these links, other selectable and non-client-specific buttons may be provided, as desired. The links in area 322 may be pre-programmed for the pop-up page 320.

In addition, when the client-specific browser software according to the present invention is distributed to a user on a machine-readable medium, it may have included with it a copy of the web page information to which these links point. Therefore, when a user loads the client-specific browser onto a storage medium associated with the user's processing or computer system, the web page information may also be loaded on to the storage medium. When the computer first runs the client-specific browser and accesses the network, the browser may cause these stored web pages to be updated on the user computer's storage medium. Thus, when the user ultimately selects one of the pre-programmed links, the web page information is displayed to the user very quickly without the need for downloading the web page at that time. Thus, the user experiences significantly decreased access times when accessing these vendor web pages. In addition, all of the web pages associated with a vendors web site may be included in the software distributed to the user. Thus, similar to the links shown in page 320, all of the web pages for the vendor may be updated when the user has accessed the network, thereby allowing for the web site information for the vendor to be displayed quickly to the user regardless of where on the web site the user visits. It is further noted that the computer operable media on which the software is distributed, such as a CDROM or diskette, may also include client-specific or co-branded information.

It is also noted that pop-up page 320 may be updated, modified or changed periodically as the user system is connected to the network. This may be accomplished in a variety of ways, including through automatic or manual download of software updates or through a dynamic link with a server system. With respect to the dynamic link, spaces or links within the pop-up page 320 could be linked to information on a remote server that provides the content for the spaces or links. For example, the client-specific mark or brand 356 and client-specific links within area 322 may be updated or dynamically provided depending upon the current status of the client. In this way, if the client changes its name or links, or otherwise desires to have a different brand or different links displayed to the user, the client-specific mark or brand 356 may be updated and modified, as desired. In addition, if the client decides to cease marketing itself through a co-branded browser as contemplated by the present invention, the software provider of the browser may then select a different client for the space. In this way, the client-specific mark or brand 356 may be updated and modified to display the new client's brand to the user.

The area 324 includes web page links to particular information that has been pre-programmed. For example, these may be for the following web page links or downloaded information: News, Sports, Weather, Stock Market, Ticker, Portal Parade (which may be an icon based web navigation tool), Vote & Win!, Your Personal TV Listings, Remind (a reminder or task utility), Yellow Pages, Free Internet Access.

In addition, the television (TV) listings link referenced by element number 368 may be TV listings that may be personalized to the user. Typical TV listings, for example, those available over the Internet, provide information that is not specific to any particular location or programming access type. Thus, for example, whether a user is located in New York City or Los Angeles, or whether the user has satellite or cable, the TV listings are the same. The user, therefore, must decipher the TV listings to determine what programming is actually available to the user at any given time. According to an additional feature of the present invention, the link 368 will take the user to a utility that allows the user to identify the user's location, programming access type, and any other desired identifying feature, such as favorite types of programming (e.g., sports, music, history, science fiction, etc.). The utility then customizes the TV listing information via the Internet so that the information displayed to the user is specific for that user and the parameters that user has selected. This customization may be provided in a variety of ways including customization at the time the network browser software is installed or customization through the network. It is noted that the content, format and selection of the broadcast information to provide to the user may be implemented as desired.

In addition, a small television-type pop-up screen may be provided that can be activated by the user, for example, through an icon positioned in the system tray of a WINDOWS graphical interface, as discussed above. The pop-up screen can provide various content choices, such as to view news, weather, sports, stock ticker, markets, or other desired topics and to download movies, music or other desired information or material. In addition, this content may be provided to the user in a language selected by the user. The content of this screen may be provided by accessing the information through an Internet-based server that provides streaming video data to download the material. In addition, this pop-up screen may be adjusted in size (minimized, full screen, etc.) and may be used to view videos streams or files from news broadcasts, client messages or any other desired source. For example, a “play” action button can provide an interface for playing video files, DVD movies and music, and a “record” action button can provide an interface for recording the same. (It is noted that the associated transfer of large video or media can be accomplished utilizing the caching techniques discussed below.) In addition, the pop-up screen may include rotating headlines or advertisements with an associated URL that are displayed to the user of the device. When the URL is selected, the linked content may be displayed through the browser or through the TV pop-up screen. It is also noted that the TV pop-up screen may be a program that is separate from the browser of the present invention. This separate TV program, therefore, may be distributed, installed and operated independently from the browser, if desired.

The area 328 includes web page links to web pages that may be selected and programmed by the user. The user may select and program any one of the buttons 352, labeled 1-7 QUIK/CLIK Pages, to provide links to selected web pages. Once selected, the browser may download and update the page information when the user is accessing the network, as discussed above. Then, when the user decides to select one of these buttons, the web page information is displayed rapidly to the user without the necessity of downloading the web page from the network. It is also noted that the URL for the link may be displayed when a pointing device moves over any one of the buttons 352. It is also noted that the element 366 points to additional information that may be included such as instructions, copyright notice, and branding and marketing phrases, such as “Blue.Sky Airlines” and “Web Without Waiting.”

In addition, if desired, the user can selectively activate a quick browsing feature that provides for pre-downloading of web page linked to a web page being viewed. With this feature activated, the browser begins downloading linked web pages once a user begins viewing a selected web page. When user does ordinary browsing, the user can typically browse 1-2 sites simultaneously. So, while user reading the content of web page, the Internet channel is free and often not used. Thus, while the user reads or views the content of the current web page, other content linked to that page can be downloaded. This quick browsing feature may improve browsing speeds by as much as 30-50% or more. This feature is highly advantageous because most users are interested in the speed at which content is delivered. In addition, this speed enhancement is particularly advantageous for situations where the user is paying for network access by time. For example, some countries charge for local telephone line usage. It is noted that this feature can also take advantage of the multi-thread download technique discussed further below which further improves the utilization of the entire width of the available Internet channel bandwidth.

In the embodiment shown in FIG. 3C, it is understood that eCLIK Corporation is the software developer of the network interface and also may provide network related services such as e-mail accounts and web page hosting. In the embodiment shown, Blue.Sky Airlines is a single third-party vendor whose client-specific information is displayed in a dedicated and continuous manner to the user. It is noted that the eCLIK related information could be removed if desired from the network interface, and that the client-specific information could refer to one or more vendors. It is further noted that the particular links, configurations and format shown in FIG. 3C are intended as an example and should not be seen as limiting the invention.

Looking now to FIG. 4A, a block diagram is depicted of an embodiment for a client-specific network browser interface 400 according to the present invention. Like standard network browsers, the browser interface 400 includes a area 402 that provides space for displaying the contents of network web pages. Within this area 402 is where typical web pages often display product and service vendor banner advertising information that is associated with the web page. The browser interface 400 also includes area 404 that provides space for program command and control functions and, unlike prior network browsers, provides space for client-specific information. Thus, the browser 400 according to the present invention has dedicated, client-specific information that is displayed to the user in the program space of the interface. It is noted that these areas in the embodiment of FIG. 3A are for example purposes and other arrangements for a client-specific browser interfaces 400 would be equally advantageous, according to the present invention.

FIG. 4B is a more detailed diagram of an embodiment for a client-specific browser interface 400 for a client-specific network interface according to the present invention. In the example, browser interface 400 includes program and client-specific information area 404 and web page content space 402. In addition, a program header line 405 is shown that may provide windowing control in a graphical user interface environment, as well as program source information, such as the “e” icon symbol.

Looking to the details of area 404 in the example shown in FIG. 4B, item 432 provides an indication of the current web site being viewed and a drop-down menu for prior web sites visited. Item 430 is the client-specific marking “Blue.Sky Airlines” for the browser program area. The line 438 demarcates the area 404, which includes program and client-specific information, from the area 402, which includes information for the particular web page being viewed. It is noted that the button labels may provide an identifiably different change as a pointer is passed over them, for example, the “Favorites/Bookmarks” button 434 may change color if a pointer passes over it. Also, the “Online” button 426 and the “NOW Offline” button 424 may be provided such that one of them is selected at all times, and the selected button is displayed in an identifiably different manner. Again, this difference may be, for example, a color change in the font. In addition, these buttons may be provided such that there is a single status button 424 that provides the current connection status of the device and/or actions that may be requested concerning this connection status, for example, “NOW Offline,” “Go Online,” “NOW Connecting,” “NOW Online,” and/or any other desired indication.

In addition, with respect to “favorites” or “bookmarks,” for example, that identify links to web pages that are of particular or continued interest to the user, the browser of the present invention allows not only for the user to select links to save but also allows access to such links saved in other browser programs. For example, through a drop down menu, the browser allows viewing and selection of “Bookmarks” saved with respect to NETSCAPE browsers and viewing and selection of “Favorites” saved with respect to WINDOWS INTERNET EXPLORER browsers. Also, unlike these two browsers, the browser of the present invention allows use of these links from other browsers without removing the associated files from their original disk locations as used by the competing browsers.

The two spaces 428 are client dedicated commercial spaces where client-specific advertising may be displayed to the user. The content of this space may be fixed at the time the browser is installed, or it may be updated and changed periodically when the user is connected to the network. For example, a service provider, such as eCLIK Corporation in the example embodiment, may download different content for the spaces 428 when the user is accessing the network. This space, therefore, would be dynamically linked to the eCLIK server. This linking may be accomplished in any way desired, as would be understood by one of skill in the art. As stated above, for example, such content may be displayed using a document protocol, such as hyper-text markup language (“HTML”). If desired, the client may also be given direct control of these HTML-based spaces 428, so that the service provider for this dynamically linked content is in effect the client rather than a third party service provider, such as eCLIK Corporation. Thus, the client directly and dynamically fills this spaces with desired content, such as messages and iimages.

It is also noted that other items and spaces within the browser interface 400 may be updated or changed periodically as the user system is connected to the network. As indicated above with respect to the pop-up page 320, these modifications may be accomplished in a variety of ways, including through automatic or manual download of software updates or through a dynamic link with a server system. For example, the client-specific marking 430 may be updated or dynamically provided depending upon the current status of the client. In this way, if the client changes its name or otherwise desires to have a different brand displayed to the user, the client-specific marking 430 may be updated and modified, as desired. In addition, if the client decides to cease marketing itself through a co-branded browser as contemplated by the present invention, the software provider of the browser may then select a different client for the space. In this way, the client-specific marking 430 may be updated and modified to display the new client's brand to the user.

On-line and off-line buttons 426 and 424 may also be provided, as shown in FIG. 4B. The “On Line” button 426, when selected, may connect the user to the network. The “Off Line” button 424, when selected, may disconnect the user from the network. It is noted that depending upon the type of network and the type of network access the user has, the off-line and on-line buttons 424 and 426 may not be needed. For example, if the network is the Internet and the connection is a modem connection, selection of the on-line button 426 causes the user's computer to dial-in and connect to the Internet. Selection of the off-line button 424 would then causes the user's computer to disconnect from the Internet. However, if the network is the Internet and the connection is a DSL or cable modem connection where the user's computer is always accessing the network, the off-line and on-line buttons 424 and 426 would likely not be needed. It is again noted that the current invention is not limited to any particular network type or access technology.

Looking further at the program space 404 in FIG. 4B, various additional buttons and/or links are provided. Item 406 is a “Back” button that takes the user back to previously viewed web pages. Item 422 is a “Ahead” button that takes the user forward to subsequently viewed web pages. Item 407 is a “Stop” bottom that ends a web page access, for example, if it is taking too long to actively download. Item 415 is a “Misc.” button that may provide miscellaneous control and program information. Item 435 is a “Send Page” button that may provide a quick tool for a user to send the web page to another person, for example, through an e-mail message. Item 437 is a “Home” button that may send a user to the browser home page. Item 420 is a “Help” button that will take the user to a help utility. Item 448 is an “Int.” button that may provide a selection of what default international language the user would like to use. The icon 447, as also identified below, may indicate to the user what language has been selected. Item 412 is a “Mail” button that indicates to a user that there is new mail and takes the user to an e-mail utility. As indicated above, both e-mail accounts and Internet service may be one of the services provided by a Internet service provider, which can be, for example, the software provider eCLIK Corporation in the embodiments of FIGS. 3C and 4B.

Item 408 is “Printer” button that takes the user to a printing utility. According to the present invention, this printing utility allows the user to select web pages and/or e-mails that will be printed during low usage times, such as overnight. Thus, if the user desires, the morning version of a selected newspaper may be printed overnight so that it is available to the user for reading in the morning. Similarly, the user may select that any unread e-mails be printed overnight so that the user may review them first thing in the morning. It is noted that other printing functionality, for example, scheduled printing of television listings, weather reports, news information, sports, travel or other information may be provided as desired. It is further noted that the printing utility, as described here and above, may be a program that is separate from the browser of the present invention. This separate printing utility, therefore, may be distributed, installed and operated independently from the browser, if desired.

Item 434 provides a drop-down menu for favorite sites. The user may also access a web page download timing utility. This timing utility allows the user to specify the timing intervals at which the browser will automatically access the network and allows the user to specify how “deep” into the web page links should web pages be downloaded. For example, the user could specify that a particular web site be downloaded every morning and that every link on that web site also be downloaded (link depth of one). If more of the web site were desired, the user could set the depth to two or three or more. This “depth” setting determines how many links into the web page are downloaded. Thus, for a depth of level three, the main page is downloaded, all first level pages linked on the main page are downloaded (depth of one), all the second level pages linked on the first level pages are downloaded (depth of two), and all the third level pages linked on the second level pages are downloaded (depth of three). The user may choose to set the timing utility so that the browser uses known idle times, such as the middle of the night, to access the network and download and update the desired web pages. It is noted that through the browser interface 400, the user may program any number of desired web pages to be downloaded for later use off-line, depending upon the user's systems file storage capabilities. These web pages would be in addition to the ones described with respect to FIGS. 3A-C. As indicated above, the web page content space 402 contains the content information for the network page being viewed.

A multi-thread download technique may be utilized to enhance this scheduled delivery provided by the timing utility, as well as to enhance other download operations discussed herein, such as the quick browsing functionality and the video, movie and media file downloading discussed above. This advantageous technique uses multiple threads during downloading to better utilize the entire available bandwidth by downloading information simultaneously in different threads. Thus, regardless of the Internet connection, downloading speeds will tend to be significantly improved utilizing this multi-thread downloading technique. For example, during a scheduled download using the timing utility, the software of the present invention can download 4-6 links simultaneously as opposed to standard browsing where a single link is downloaded. It is noted that a default number of threads may be provided, such as four threads, which appears to be an optimal number for both dial-up ad LAN connections. In addition, this number of threads can be increased or decreased, as desired, and may be provided as a selectable parameter to the user. It is further noted that in addition to downloading information from Internet connected devices to local devices, this multi-threading technique may also be utilized for uploading information to other Internet connected devices.

Simple downloading (one-threaded) rarely takes advantage of the entire available Internet channel bandwidth of a web enabled device. As result, the speed of downloading is not maximum for any specified channel. By allowing several simultaneous downloading processes to be initiated and utilized, the multi-threading technique of the present invention brings the incredible ability to take advantage of the entire available bandwidth of the Internet channel for a connected device. According to this downloading technology, each file can be downloaded separately and in parallel with another files downloading.

With respect to downloading very large files, the multi-threading downloading technique can use multiple threads to download a single file thereby greatly enhancing the speed of downloading large files, such as DVD files, movies and many other media files. According to this technology, such large files can be divided into the several small parts with each part being downloaded separately and simultaneously through parallel threads. The different parts may then be re-assembled into the one file after completion of the multi-thread download. This technique allows for a significant increase in download speed of multiples times over single-thread download speeds and a correlating significant decrease in the amount of waiting time associated with large file downloads. Although the speed achieved is still limited by the maximum available Internet channel bandwidth, the technique of the present invention more fully utilizes this bandwidth to provide significantly improved download speeds.

The downloading of web page information and the scheduling of those downloads, as discussed above, provide an advantageous caching of a wide variety of web content. For example, web page content may include plain static pages, scripted pages, dynamic pages, pages with redirects and mixed pages. Plain static pages are pages represented by a set of static .html (.htm) content. Pages generated by scripts are pages that have been generated by server-side scripts using .asp, .php or other such technologies. Dynamic pages are pages that contain dynamic elements such as JavaScripts, etc. Pages with redirects are pages that utilize technology that allows content or URL requests to be redirected to some address that is different from the requested one. And mixed pages are sites that may contain any one or more of the elements listed above, as well as other types of content or page information. For example, There are a lot of different kinds of mixed sites available through the Internet, such as, the web site at the URL “www.n-tv.de” that utilizes a technique to create a set of empty frames and then only after this set of frames is loaded, downloading of the content for these frames is begun. Simple redirects are present on such sites as web sites having the URLs “www.cnn.com” and “www.northerlight.com”. It is also noted that to the extent that these sites open separate windows for the links within the sites, the caching or storage techniques of the present browser will also handle such situations and create separate windows in the stored or cached windows set.

The caching or storing of web pages and network content, including when scheduled through the timing utility, can also take advantage of the updating or re-caching techniques discussed above. For example, when network content and stored or cached web sites are updated, unchanged links and content are not downloaded again at the time of the second and subsequent updates or reloadings. This technique improves update or reloading speed and tends to minimize waiting time. In addition, different sites often use common images, pages, links or other content. To the extent that a link, page, image or other content has already been stored or cached, this information will not download it again because it presently exists in the cached information. In addition, when updating or reloading pages, content for those pages that has been removed from the site may also be removed from the stored or cached information for that site. In this way, only current state of the web page is cached or stored allowing for unneeded files and content to be deleted from the device running the browser or software of the present invention. This technique is particularly advantageous for pages that change often, such as news pages and sports pages. It is further noted that the downloading and updating or reloading of content can be conducted in a fault tolerant manner such that if there are connection errors, broken connections or other problems, the download of a specified item is re-attempted at a later time. The number of retries, for example, can be selected, such as three attempts before the item is skipped.

Items 414 and 416 are a search term field and a “Search” button, respectively, that allow the user to conduct web page searches. Once the search is initiated and results are achieved, the user may also select to enhance the search results by choosing a search boost feature. This search boost feature creates topics from the search results using cluster theory and algorithms. Thus, if desired, the user is provided with a list of topics associated with the search results. The user may then select a topic and view the web page search results that correspond to the selected topic. Creating topics from search results using cluster theory and algorithms may be implemented as desired and such techniques would be understood by those of skill the art.

An additional bar 440 may also be included just above the web page content space 402 to provide further program commands and interface information. For example, page update information 442 may be included that provides the user with the date and time for the last update of the web page being viewed. Thus, if the content were a web page that had been previously downloaded, the user would be provided an indication of when was the last time this page had been updated. If the user then desired more current web page information, the user could then select the update version command or button 444. In addition, this bar 440 may include an additional client space area, such as area 428, that allows client-specific messages or other content to be dynamically displayed to the user.

With respect to date and time indications, the browser of the present invention may also include a world time feature. This feature provides a drop-down menu or other selectable interface that allows the user to select cities, countries or other geographical locations in the world. Once the location is selected, date and time information for that location will be displayed to the user. In this way, a user can easily discern date and time information for locations throughout the world. Associated with this date and time information or separate from this date and time information, temperature and weather information can also be provided to the user concerning a selected location in the world.

As a further advantageous feature, the network browser interface 400 could include a translation utility, which is represented in the embodiment of FIG. 4B as the translate URL button 446. When selected, this translate URL button 446 may provide the user with any number of languages into which the web page content may be translated. As indicated above, the icon 447 may indicate to the user what language has been selected. For example, if a user understood the English language and identified an interesting web site in the German language, the user could translate this web page content into English by selecting the translate URL button 446. In addition, when selecting web pages to download for viewing off-line, the user may select the language or languages in which the user desires for the web page content to be stored. Thus, the translation utility may be used both in both on-line and off-line modes.

In addition, if desired, user supplied text, such as from typing in text or copying text from a document, may be translated through a dialog box interface. In other words, for example, the user may copy or type text into a input area and then request that this text me translated to a desired language. Another language associated feature is the ability to read and post messages to Internet newsgroups in a desired language. For example, through a selection menu, the user may translate messages desired to be posted to or read from a newsgroup site.

The browser may also provide a “chat” program that allows a user to quickly communicate with other online users. This chat feature includes the ability to send and receive messages that are translated to and from desired languages. For example, a user could create messages in English, have them translated to Russian for transmission and sent to a chat partner who speaks and reads only Russian. In return, messages received back, for example, in Russian, may be converted back to English for reading by the user. In addition to providing this translation functionality, the chat program of the present invention may also allow the use of identifies from other chat programs, such as Yahoo Messenger, ICQ, MSN Messenger, and AOL Instant Messenger.

The browser of the present invention may also provide security and access control for the user. This access control may be achieved in a variety of ways, for example, through identification of undesirable words or phrases and/or undesirable web sites. A word, phrase or web site may be deemed “undesirable” depending upon particular personal tastes or concerns of the user. One common usage for such access control is by parents who do not want young children to view sexually explicit material posted on the Internet. Another common usage is by companies that do not want computer resources wasted on non-business related activities. A selection menu with appropriate input boxes may be utilized to allow users to provide the words, phrases, web site links or other content to screen from those viewing the browser, unless certain user specified access codes are provided. In addition, if desired, a Internet accessible server may be provided to supply users sets of data to be used for access control. For example, as virus signatures are distributed or made available to owners of virus protection software form a Internet-based server system, the browser of the current invention may be associated with a server system from which access control data may be downloaded. In this way, a sets data for undesirable Internet content may be maintained and controlled centrally for distribution to users, for example, through updates via regular reports in a variety of forms including, for example, paper copies, electronic files and e-mails.

Related to this access control or blocking activity and functionality, the browser of the present invention also provides the ability for users to have browser or other computer activity monitored or observed for later determination of activity related to undesirable content. Through this feature, the user may select desired browser and device operations and activities for observation. Once initiated, a terminate-and-stay-resident program is activated that monitors the selected activities. For example, the observation program can monitor IP (Internet Protocol) connections made by the device and communications made through such connections. This program also allows this activity to be logged for future investigation by the user. In addition, this program may send the log information to an Internet-based server that can store the information for the user for later access. In this latter procedure, the logged information is better protected from manipulation by the person whose activities are being monitored. For example, parents may set the observation feature to monitor e-mail and web site activities of their children that include sexually explicit language or, if desired, to monitor all e-mail and web site activities of any user of the device. If the logged data is stored remotely at the server system, this data is less apt to be tampered with by the children or other persons using the device. Such bypassing of blocking software can often be easily accomplished by a computer-knowledgeable child or employee. Once remotely stored, the employer, owner, primary user or parent may then access this remotely stored data for review.

Reporting may also be provided to parents or company administrators, for example, via regular period reports in a variety of forms including paper copies, electronic files and e-mails. This report may include an itemized list of activities, for example, with respect to Internet browsing activity, the web sites URL, date, from/to time accessed, identification of person using the device, and other details, as desired. In addition, the user may select when a report is generated, for example, what days of the week to send a report, every “x” number of days, time of day at which to send a report, every “x” number of logged items, or any other desired selectable trigger. In addition, if desired, the server system may notify the parent of undesirable activities, for example, of all activities are being observed. In this way, the parent need not personally review the logged data unless notified that questionable content, e-mails, etc. have been logged. As above, undesirable content and activities may be user-defined and may be based upon sets of data stored by a server system, or any other selection procedure, as desired.

It is noted that the access control and observation functionality may be programs that are separate from the browser of the present invention. This separate access control program or observation program, therefore, may be distributed, installed and operated independently from the browser, if desired.

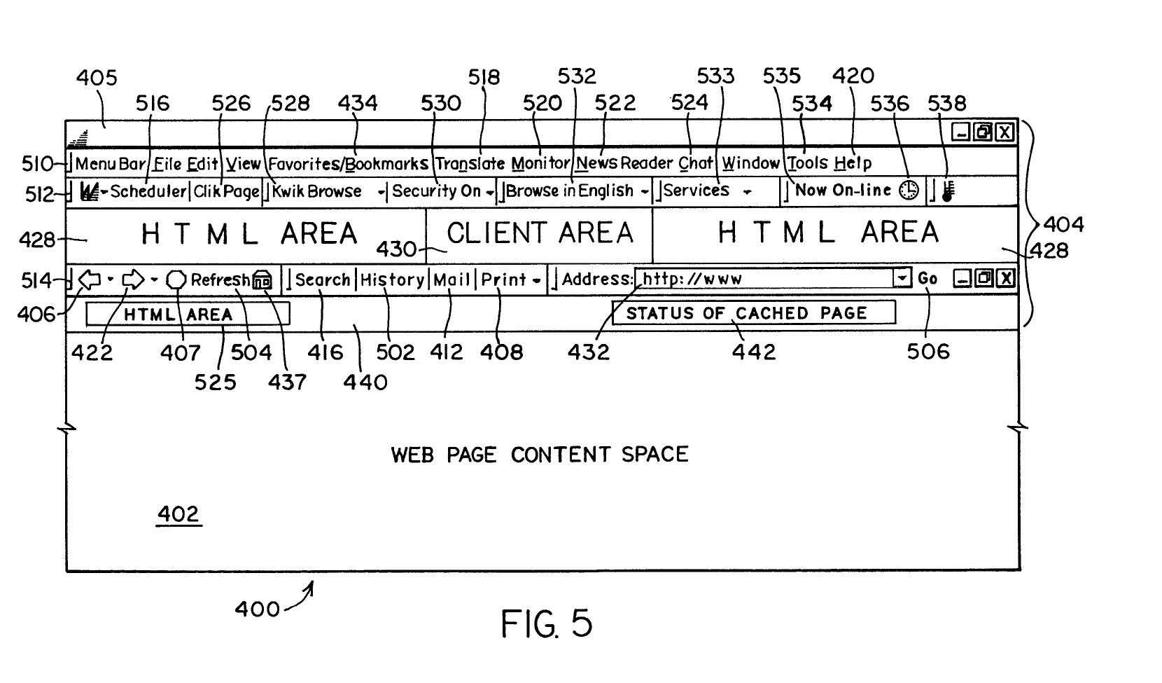

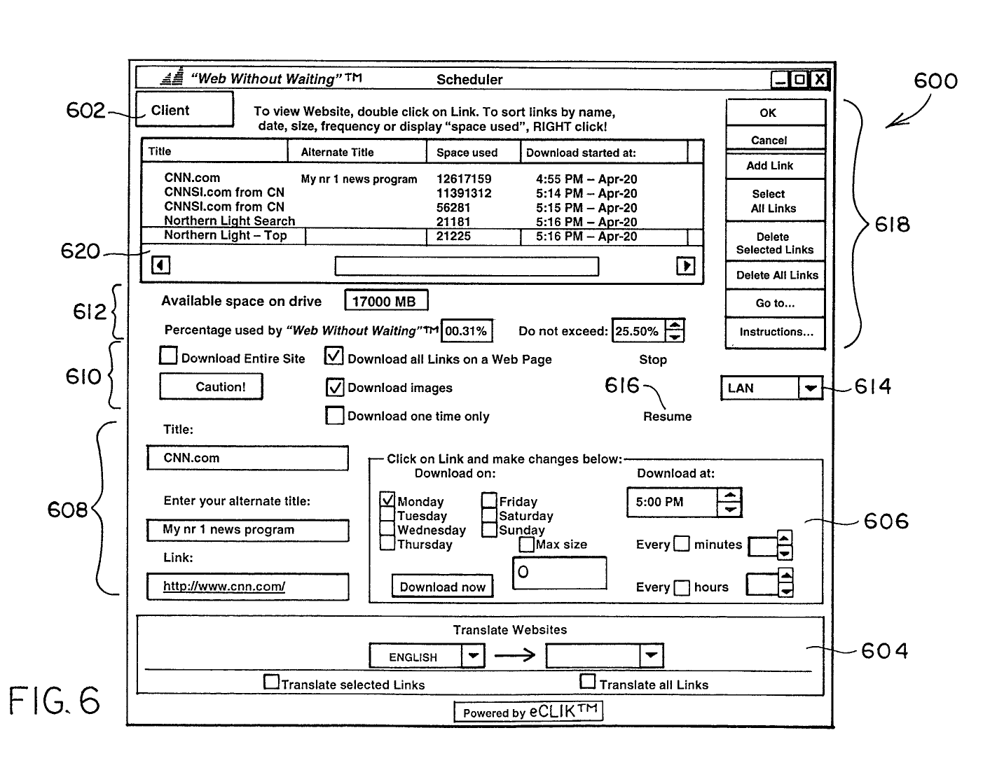

With respect to the browser of the present invention and related features as discussed above, FIGS. 5-8 provide additional example user interfaces. In particular, FIG. 5 depicts an example interface for the browser, and FIGS. 6-8 provide example interfaces for the web page download scheduler feature, the activity observation feature and the access control feature, respectfully, that were each discussed above.

Now turning to FIG. 5, an alternative embodiment of a client-specific browser interface 400 is depicted for a client-specific network interface according to the present invention. In this embodiment, area 404 includes five menu bars along with the content spaces 428 (which may be HTML-based as discussed above) and the client identification area 430. These menu bars are bar 405 that provides header information, bar 510 that provides drop-down selection menus for certain program functions, bar 512 that provides additional drop-down selection menus for additional program functions, bar 514 that provides primarily web site navigation related functions and drop-down selection menus and bar 440 that provides additional page information.

In addition to functional items depicted and discussed with respect to FIG. 4B above, FIG. 5 includes additional button commands and drop-down menus. For example, in bar 514, a “Refresh” button 504, a “History” button 502 and a “Go” button 506 are included, which have refresh, web site visit history and URL functions, respectively, that are well known in typical browsers. In bar 510, in addition to “File,” “Edit,” “View,” and “Window” menus, which are found in many program interfaces, additional buttons are provided related to functions described above with respect to the browser of the present invention. These include the “Favorites/Bookmarks” menu 434, the “Translate” menu 518, the “Monitor” menu 520 (which includes options to open windows monitoring various activities such as news, weather, sports, and stock activity), the “News Reader” menu 522, the “Chat” menu 524 (which provides access to the chat features discussed above), and the “Tools” menu 534 (which includes options for the access control and observation functions discussed above).

Looking to bar 512, it further includes a “Scheduler” menu 516 for scheduling web page downloads, a “Clik Page” button 526 for accessing the client-specific pop-up page, a “Kwik Browse” 528 button for accessing the quick browsing feature discussed above, a “Security” button 530 for accessing security features along with a selection and associated indication for turning security “on” and “off.” In addition, a “Browse” button and drop-down menu 532 allows selection of the language with which to view the selected web page. A “time” icon 536 and a “temperature” icon 538 are also provided to allow the determination of time, temperature and weather of a selected geographical location, as discussed above. Also, a “Services” button 533 and drop-down menu are provided for selecting other desired services. Looking to bar 440, a dynamic client content space 525 (which may be HTML-based as with spaces 428) can be included with respect to the other web page related information, as discussed above. The “Now On-Line” button 535 provides a toggle function similar to that provided by buttons 424 and 426 of FIG. 4B.

FIG. 6 shows an example user interface 600 for the web page download scheduler feature. It is noted that the controls and settings shown with respect to this example interface 600 may be modified and altered to provide more, less or different features to the user, as desired. As with the embodiments described above, the interface 600 includes branding information. For example, the menu bar at the top of the interface 600 and a banner at the bottom of interface 600 may include designations identifying the source of the browser, such as the phrases “WEB WITHOUT WAITING^{™}” and “POWERED BY eCLIK^{™}”. In addition, an area 602 may include a client brand thereby providing a co-branded or client-specific browser as discussed above. Furthermore, this area 602 may also include dynamic client content as discussed above, for example, with respect to spaces 428 and 525 in FIG. 4B and FIG. 5, respectfully.

Looking in more detail to the interface 600, a variety of example control and setting information related to the scheduler function is depicted. The area 620 includes a list of web pages that have been selected for scheduled download and associated parameters, such as title, alternative title, spaced used, download start time and download stop time. The stop/resume control 616 allows the user to stop and resume specific scheduled downloads during the downloading process, if desired. The buttons 618 provide various controls, such as adding, selecting and deleting links.

The areas 604, 606, 608, 610, 612 and 614 provide example control and setting features for scheduling web page downloads. In particular, area 604 allows selection of language translations that can depend upon the language of the site and the language to which to be translated. Area 606 allows selection of the timing for downloads, such as day of the week, time of day, and frequency of download (e.g., every X minutes, every Y hours). In addition, maximum download size and a immediate download feature are also provided. Area 608 provides input areas for the user to define title, alternate title and link information. Area 610 provides additional controls for the download, such as single time download, image download, downloading all links on the web page, and downloading the entire web site. As shown, a warning or “Caution” notice can be provided with respect to the last feature because of the large download size that may be required for many sites. Finally, area 612 can provide usage limitations such as currently available space, the percentage of storage space utilized by scheduled downloads, and a maximum overall percentage that may be used.

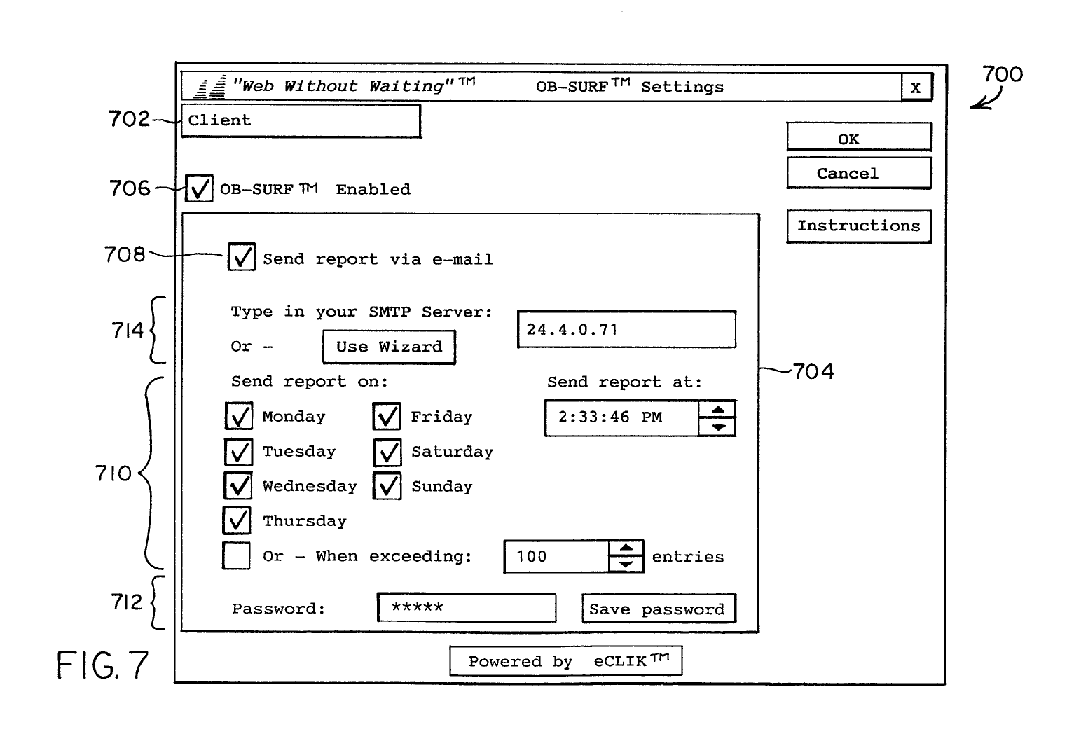

FIG. 7 depicts an example interface 700 for settings with respect to the activity observation feature discussed above. It is noted that the controls and settings shown with respect to this example interface 700 may be modified and altered to provide more, less or different features to the user, as desired. As with the embodiments described above, the interface 700 includes branding information. For example, the menu bar at the top of the interface 700 and a banner at the bottom of interface 700 may include designations identifying the source of the browser, such as the phrases “WEB WITHOUT WAITING^{™}” and “POWERED BY eCLIK^{™}”. In addition, an area 702 may include a client brand thereby providing a co-branded or client-specific browser as discussed above. Furthermore, this area 702 may also include dynamic client content as discussed above, for example, with respect to spaces 428 and 525 in FIG. 4B and FIG. 5, respectfully.

Looking in more detail to the interface 700, a variety of example control and setting information related to the scheduler function is depicted. Selection item 706 allows for the observation feature to be selectively enabled (named OB-SURF^{™} in the embodiment depicted). Selection item 708 determines whether or not a report is desired to be sent via an e-mail message. The area 710 selectable items and input areas that determine when a report will be sent relating to the observed activities. In this embodiment, these controls include day of the week, time of day, and number of entries. The area 714 includes an identification of the IP address for one or more outgoing mail servers (SMTP Server, IP address of 24.4.0.71 as depicted) that should be utilized by the system. Area 714 also includes a selection button for enabling a “wizard” that will search the system and determine what e-mail or SMTP servers are loaded within the system and that will then allow the user to select one or more SMTP servers that should be used. This SMTP server selection may be useful, for example, to determine if a user is attempting to utilize a mail server separate from an authorized mail server. Area 712 includes password selection and save controls.

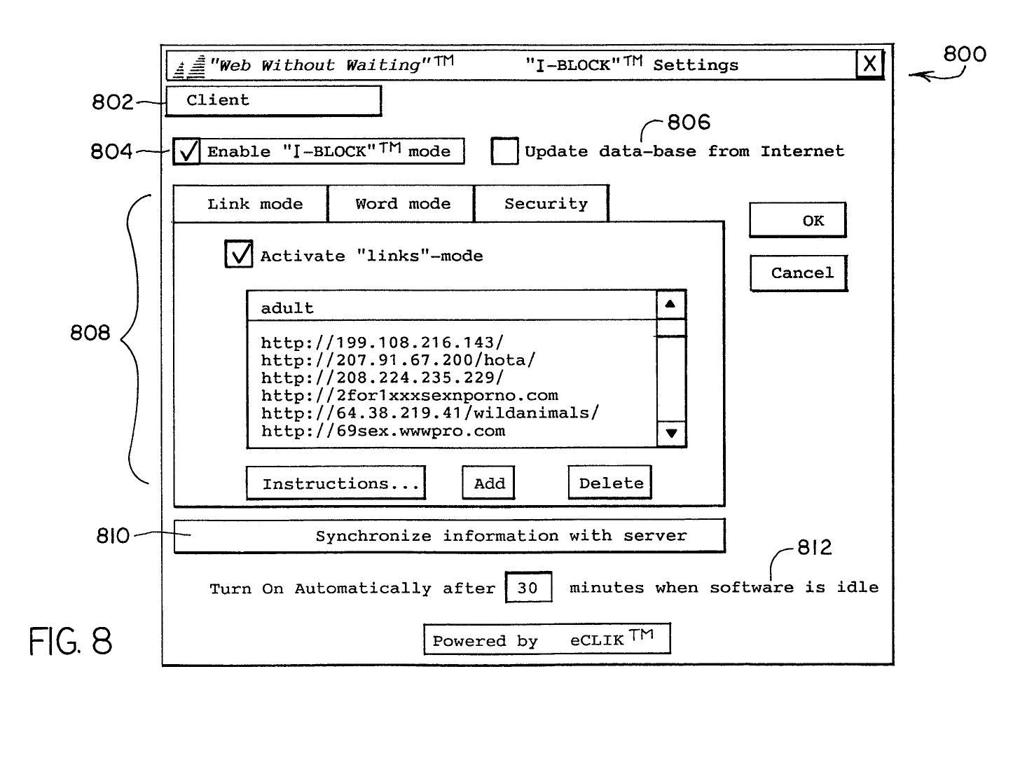

FIG. 8 depicts an example interface 800 for settings with respect to the access control feature discussed above. It is noted that the controls and settings shown with respect to this example interface 800 may be modified and altered to provide more, less or different features to the user, as desired. As with the embodiments described above, the interface 800 includes branding information. For example, the menu bar at the top of the interface 800 and a banner at the bottom of interface 800 may include designations identifying the source of the browser, such as the phrases “WEB WITHOUT WAITING^{™}” and “POWERED BY eCLIK^{™}”. In addition, an area 802 may include a client brand thereby providing a co-branded or client-specific browser as discussed above. Furthermore, this area 802 may also include dynamic client content as discussed above, for example, with respect to spaces 428 and 525 in FIG. 4B and FIG. 5, respectfully.

Looking in more detail to the interface 800, a variety of example control and setting information related to the access control function is depicted. Selection item 804 allows the access mode feature to be selectively enabled (named IBLOCK^{™} in the embodiment depicted). Area 808 provides controls and input areas for identifying the content to be controlled. As discussed above, a variety of techniques may be utilized to identify content. For example, as depicted, URLs may be included under the “Link mode” tab, and words and phrases may be included under the “Word mode” tab. Each of these modes may also be selectively enabled through a selection item. Within area 808, a “Security” tab is also provided for desired security features. As also discussed above, access control data may also be downloaded from a Internet server based database such as through selection item 806, which provides for periodic updates from a server, or through button 810, which provides for a selective synchronization of data with information on the server. Item 812 refers to a timing selection for selecting when the updating or synchronization will occur.

It is again noted that the interface embodiments depicted are examples and other interfaces may be utilized, as desired, with respect to the browser and related features of the present invention. In addition, additional and different functions, features, controls and settings may be implemented as part of the browser of the present invention.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the shape, size and arrangement of parts. For example, equivalent elements may be substituted for those illustrated and described herein, and certain features of the invention may be utilized independently of the use of other features, all as would be apparent to one skilled in the art after having the benefit of this description of the invention.

I claim:

1. A client-specific network browser interface, comprising:
a user interface;
a first area within the user interface that includes space in which network information is displayed; and
a second area within the user interface that includes space in which client-specific information is displayed substantially continuously to a user, the client-specific information being information dedicated to at least one vendor that is not a developer of the browser interface program, and at least a portion of the client-specific information being updated with content provided by a remote server during times when the network is being accessed.

2. The client-specific network browser interface of claim 1, wherein at least some of the content is provided in an HTML-based format.

3. The client-specific network browser interface of claim 1, wherein the updated portion of the client-specific information comprises at least two distinct spaces that display dynamically linked client-specific information.

4. A client-specific network browser interface, comprising:
a user interface;
a first area within the user interface that includes space in which network information is displayed; and
a second area within the user interface that includes space in which client-specific information is displayed substantially continuously to a user, the client-specific information being information dedicated to at least one vendor that is not a developer of the browser interface program; and
program command and control information including a link to settings that allow access to network content to be controlled.

5. The client-specific network browser interface of claim 4, wherein the network comprises the Internet, and wherein the content access control settings comprises web site addresses that identify web sites that should not be accessed.

6. The client-specific network browser interface of claim 4, wherein the network comprises the Internet, and wherein the content access control settings comprises words or phrases that identify web site content that should not be accessed.

7. The client-specific network browser interface of claim 4, wherein the network comprises the Internet, and wherein content access control settings comprise data obtained from a database located on a remote server.

8. A client-specific network browser interface, comprising:
a user interface;
a first area within the user interface that includes space in which network information is displayed;
a second area within the user interface that includes space in which client-specific information is displayed substantially continuously to a user, the client-specific information being information dedicated to at least one vendor that is not a developer of the browser interface; and
program command and control information including a link to settings that allow network related activity to be observed and logged.

9. The client-specific network browser interface of claim 8, wherein the network comprises the Internet, and wherein a logged data representative of network related activity is stored on a remote server.

10. The client-specific network browser interface of claim 9, wherein at least a portion of the logged data is accessible for review by an authorized person.

11. The client-specific network browser interface of claim 9, wherein at least a portion of the logged data is forwarded from the remote server to an authorized person for review.

12. The client-specific network browser interface of claim 8, wherein the network browser interface comprises a graphical user interface.

13. The client-specific network browser interface of claim 8, wherein the network browser interface comprises a text-based or character-based user interface.

14. A processing system having a client-specific network browser interface, comprising:
an internal processor;
a display device coupled to the internal processor;
an input device coupled to the internal processor, the input device allowing for data or commands to be input to the processing system;
a communication device coupled to the internal processor and configured to allow the processing system to communicate to a network; and
a browser interface configured to be displayed through the user display; the browser interface comprising:
a first area that includes space in which network information is displayed; and
a second area that includes space in which client-specific information is substantially continuously displayed to a user, the client-specific information being information dedicated to at least one vendor that is not a developer of the browser interface program, and at least a portion of the client-specific information being updated with content provided by a remote server during times when the network is being accessed.

15. The processing system of claim 14, wherein at least some of the content is provided in an HTML-based format.

16. A processing system having a client-specific network browser interface, comprising:
an internal processor;
a display device coupled to the internal processor;
an input device coupled to the internal processor, the input device allowing for data or commands to be input to the processing system;
a communication device coupled to the internal processor and configured to allow the processing system to communicate to a network; and
a browser interface configured to be displayed through the user display; the browser interface comprising:
a first area that includes space in which network information is displayed;
a second area that includes space in which client-specific information is substantially continuously displayed to a user, the client-specific information being information dedicated to at least one vendor that is not a developer of the browser interface program; and
program command and control information including a link to settings that allow access to network content to be controlled.

17. The processing system of claim 16, wherein the network comprises the Internet, and wherein content access control settings comprise data obtained from a database located on a remote server.

18. A processing system having a client-specific network browser interface, comprising:
an internal processor;
a display device coupled to the internal processor;
an input device coupled to the internal processor, the input device allowing for data or commands to be input to the processing system;
a communication device coupled to the internal processor and configured to allow the processing system to communicate to a network; and
a browser interface configured to be displayed through the user display; the browser interface comprising:
a first area that includes space in which network information is displayed;
a second area that includes space in which client-specific information is substantially continuously displayed to a user, the client-specific information being information dedicated to at least one vendor that is not a developer of the browser interface program; and
program command and control information including a link to settings that allow network related activity to be observed and logged.

19. The processing system of claim 18, wherein the network comprises the Internet, and wherein a logged data representative of network related activity is stored on a remote server.

20. The processing system of claim 19, wherein at least a portion of the logged data is accessible for review by an authorized person.

21. The processing system of claim 19, wherein at least a portion of the logged data is forwarded from the remote server to an authorized person for review.

22. The processing system of claim 18, wherein the network browser interface comprises a graphical user interface.

23. The processing system of claim 18, wherein the network browser interface comprises a text-based or character-based user interface.

24. The processing system of claim 18, wherein the processing system is a personal computer.

25. The processing system of claim 18, wherein the communication device is a dial-up modem.

26. The processing system of claim 18, wherein the communication device provides a wireless connection.

27. A processing system having a network browser interface, comprising:
an internal processor;
a display device coupled to the internal processor;
an input device coupled to the internal processor, the input device allowing for data or commands to be input to the processing system;
a communication device coupled to the internal processor and configured to allow the processing system to communicate to a network; and
a browser interface configured to be displayed through the user display; the browser interface comprising a first area that includes space in which network information is displayed and being configured to provide multi-thread data transfers through the network.

28. The processing system of claim 27, wherein the browser interface further comprises a second area that includes space in which client-specific information is substantially continuously displayed to a user, the client-specific information being information dedicated to at least one vendor that is not a developer of the browser interface program.

29. The processing system of claim 27, wherein the browser interface further comprises program command and control information including a link to settings that determine whether or not multi-thread transfers are utilized for data transfer through the network.

30. The processing system of claim 27, wherein the browser interface further comprises program am command and control inform ation including a link to settings that determine a number of threads that will b e utilized.

31. The processing system of claim 27, wherein the network comprises the Internet and the browser interface is configured to download content associated with links on a web page once the web page is viewed instead of waiting for a new link to be selected by a user.

32. The processing system of claim 27, wherein the browser interface further comprises program command and control information including a link to access time control settings, the access time control settings allowing a user to select network information to download and to determine when and how often the selected network information is downloaded or updated from the network, the selected network information being downloaded using multi-thread data transfers.

33. A method for providing network information through a client-specific network interface, comprising:
displaying network information within a first area within a user interface;
further displaying client-specific information within a second area within the user interface, the client-specific information being information dedicated to at least one particular vendor that is not a developer of the network interface program; and
updating at least a portion of the client-specific information with content provided by a remote server during times when the network is being accessed.

34. The method of claim 33, wherein at least some of the content is provided in an HTML-based format.

35. A method for controlling content accessed through a client-specific network interface, comprising:
displaying network information within a first area within a user interface;
further displaying client-specific information within a second area within the user interface, the client-specific information being information dedicated to at least one particular vendor that is not a developer of the network interface program; and
allowing access to network content to be controlled through content access control settings.

36. The method of claim 35, wherein the network comprises the Internet, and wherein content access control settings comprise data obtained from a database located on a remote server.

37. A method for controlling content accessed through a client-specific network interface, comprising:
displaying network information within a first area within a user interface;
further displaying client-specific information within a second area within the user interface, the client-specific information being information dedicated to at least one particular vendor that is not a developer of the network interface program; and
allowing network related activity to be observed and logged through network observation settings.

38. The method of claim 37, wherein the network comprises the Internet, and further comprising storing a logged data representative of network related activity on a remote server.

39. The method of claim 38, wherein at least a portion of the logged data is accessible for review by an authorized person.

40. The method of claim 38, further comprising forwarding at least a portion of the logged data from the remote server to an authorized person for review.

41. A method for enhancing data transfers for a network user interface, comprising:
displaying network information within a first area within a user interface; and
transferring data for the network user interface through the network utilizing multi-thread data transfers.

42. The method of claim 41, wherein the browser interface further comprising displaying a second area that includes space in which client-specific information is substantially continuously displayed to a user, the client-specific information being information dedicated to at least one vendor that is not a developer of the browser interface program.

43. The method of claim 41, furthering providing program command and control information including a link to settings that determine whether or not multi-thread transfers are utilized for data transfer through the network.

44. The method of claim 41, wherein the network comprises the Internet and the method further comprises downloading content associated with links on a web page once the web page is viewed instead of waiting for a new link to be selected by a user.

45. The method of claim 41, wherein the data transfer comprises video files.
